(19) United States
(12) Patent Application Publication
(10) Pub. No.: US 2022/0095583 A1
(43) Pub. Date: Mar. 31, 2022

(54) Horse Feeding Device

(71) Applicant: Embedded Control B.V., Ruurlo (NL)

(72) Inventor: Johannes Petrus van de Kamer, Ruurlo (NL)

(21) Appl. No.: 17/422,544

(22) PCT Filed: Nov. 27, 2019
(86) PCT No.: PCT/NL2019/050786

§ 371 Date: Jul. 13, 2021

(30) Foreign Application Priority Data
Jan. 14, 2019 (NL) 2022392

(51) Int. Cl. A01K 5/02; A01K 5/01

(52) U.S. Cl. CPC A01K 5/0291; A01K 5/01; A01K 5/0275

(57) ABSTRACT

The present invention is in the field of a horse feeding device and a method of feeding a horse. The feeding device (100) allows for a controlled and typically in time limited uptake of feed by a horse, taking into account the natural behavior of the horse in this respect. It therewith reduces various physical disorders and improves mental well-being of the horse.

### CROSS-REFERENCE TO RELATED APPLICATIONS

This application is the United States national phase of International Application No. PCT/NL2019/050786 filed Nov. 27, 2019, and claims priority to The Netherlands Patent Application No. 2022392 filed Jan. 14, 2019, the disclosures of which are hereby incorporated by reference in their entirety.

### BACKGROUND OF THE INVENTION

### Field of the Invention

The present invention is in the field of a horse feeding device and a method of feeding a horse. The feeding device allows for a controlled and typically in time limited uptake of feed by a horse, taking into account the natural behavior of the horse in this respect. It therewith reduces various physical disorders and improves mental well-being of the horse.

### Description of Related Art

In the wild, horses spent over 14 hours per day on grazing, typically relatively evenly spread over the whole day. Grazing typically continues during the night. Only for short periods of time the grazing stops, e.g. for short naps, relaxing or socializing with the other horses of the group.

The digestion system of a horse is adapted for a continuous flow of grass. The stomach of a mature horse has a capacity of approximately 8-15 liters and continuously produces acid to digest the grass. The acid is neutralized by salivary that is produced during the chewing of the grass, hence the more a horse chews, the more salivary is produced. This small volume of a horse's stomach, in combination with a rapid passage of food from the stomach, imply that horses should eat substantially continuously and slowly.

In captivity, the horse is typically allowed to graze in a meadow for a period of 6 hours during daytime. For the remaining 18 hours the horse is kept indoors; in some cases the horst is always kept indoors, such as during fall and winter time, to prevent damage to the meadow. When kept indoors, dried grass, also referred to as hay, is provided every 3 to 4 hours, typically when a horse owner is not sleeping; in such cases a horse is fed 4-6 times per day. It is noted that more typically a horse is fed 2-4 times a day. This results in a last feeding round late in the evening and a first feeding round early in the morning. The time between these two feeding rounds can easily exceed 7 hours. So a horse does not eat continuously and slowly in most cases, but intermittently and fast instead and also in too large quantities at once.

These long intermittent periods of not being able to consume grass cause digestion problems for horses. The stomach acid is continuously produced, if there is no grass in the stomach this will lead to stomach ulcers causing a serious irritation for the horse. If not treated it will result in condition loss and possibly even death. And further, if the feeding routine is not changed the ulcers will come back.

In the meadow a horse will cut of small pieces of the grass and make many chew movements producing a lot of salivary. The grass enters the stomach in a slow rate in combination with the salivary, the stomach acid is neutralized and the stomach content is slowly released to the intestines for further digestion. On the contrary, indoors dried grass is provided in relatively too large portions. The feeding rate is much higher than on the meadow since no cutting is required, less chewing motions are made and less salivary is produced. As a result, the amount of grass and the ratio of grass versus salivary is not optimal. Most grass is not correctly digested causing intestines problems like colic.

A second problem caused by the disruption in the normal feeding behavior of a horse is a mental disturbance. As indicated, a horse spends in nature over 14 hours on grazing. Indoors this is reduced to a total of 2 to 3 hours of eating dried grass. This disrupts the horse mental state, which may be compared with structurally decreasing the amount of sleep to two hours for a human being. As a result, the horse may develop a series of abnormal behaviors, such as shaking his head for an extended amount of time, walking in circles, biting/kicking the walls, and deeply inhaling air while biting down of an object.

A known technique to increase the time a horse needs to consume a specific amount of dried grass is to put steel bars on top of the dried grass. This will require the horse to pull the dried grass trough the bars using their lips and as a result slow down the amount of grass it consumes in a specific period of time. Another option is to place the dries grass inside a net and hang it from the ceiling. These so called ‘slow feeders’ do indeed slow down the feeding rate, but typically this means that the grass is still consumed in about twice the amount of time without such a feeder. This does not solve the problem that during the night as the horse does not have access to grass and stomach acid is produced or abnormal behavior is executed.

For better understanding some typical numbers are provided. An average horse requires 1.5 kg of dried grass per 100 kg body weight per day; hence for a 600 kg horse this means 9 kg of dried grass, so 2.25 kg of dried grass per feeding round when feeding 4 times per day. The 2.25 kg of dried grass is consumed in 30 to 45 minutes; when a slow feeder is used this can be extended to 1 to 1.5 hours. In total the 9 kg of grass is consumed in 2 to 3 hours, or likewise 4 to 6 hours using a slow feeder.

It is however preferred to slow this down further so that the 9 kg of dried grass is consumed over the full 14 hours, the time that is typically spent in nature for grazing. This can't be achieved using a slow feeder since the bars can't be placed closer to each other since at that moment the horse can no longer access the dried grass anymore. In other words, the amount of food provided per unit time in prior art devices is still too large.

Some prior art devices recite systems for providing forage.

AT 13 443 U1 recites a device for providing hay to animals, wherein the hay is in large quantities (bulk) such as in the form of bales. Multiple access points are provided and horses need either turn their neck sideways or upwards in order to eat, which is amongst other ergonomically unfavorable.

US 2008/0029034 A1 recites an automatic animal feeder with a food hopper connected to a feeding trough. Bulk animal food loaded into the hopper transfers into the feeding trough. A lid covers the feeding trough, preventing access to the animal food. An automated drive mechanism having a timer opens the lid, thereby allowing access to the animal food in the feeding trough, at preset intervals, in principle allowing unlimited consumption of food, typically in the form of pellets or the like as food needs to pass through a bend. The automatic animal feeder can be used to train wild game to feed during certain desired periods, such as daylight hours.

U.S. Pat. No. 4,976,222 B1 recites a horse feeder that includes a receptacle surmounted by a grille. The grille includes an upstanding arch located near the back of the receptacle through which the hay is inserted into the feeder from the rear. The grille also includes bars that slope downwardly and frontward to confine the feed during the entire feeding period. These features permit the feeder to be mounted closer to the ground than is possible with conventional feeders, which enables the horse to feed in a more natural grazing position. This horse feeder may slow down consumption, but it does not limit consumption.

US 2006/070578 A1 recites a livestock hay saver which protects hay from the elements and contamination. The apparatus has timer-operated doors which provide control to completely automated means for providing feed to a multitude of horses and cattle. As above it is only accessibly for animals under ergonomically unfavorable conditions. Its battery-operated, solar-recharged power system makes it completely portable and minimizes the need for user attention or maintenance; however it makes the system in principle only suited for outdoor applications.

DE 20 2013 002482 U1 recites a feeding system having at least one feeding device comprising at least one container means with at least one storage area for storing at least one feed and at least one output section having at least one opening for the output of the feed to the to be fed animals, wherein the opening is at least partly closed by at least one controllable closing device and wherein the closing device is movable by at least one drive means, characterized in that at least one controllable moistening device is provided which is suitable and adapted to feed selectively the output area to moisten at least partially. The system is relatively large, comprises many void space, whereas is suffers from the same ergonomical problems as above.

If there are moving parts that can come into contact with the horse, anti-crush protection is required in view of safety requirements. Such is difficult, as there is no system in the world that can see if one accidentally or on purpose puts a head in the middle of a trajectory of a moving part. Horses quickly realize that if they keep their head in the middle, the system will block and they can continue to eat. So a security measure must be setup.

Hence prior art feeding devices still cause physical and mental problems for horses, may still allow unlimited consumption of feed as well as fast consumption thereof, as well are typically not applicable in smaller and confined spaces, such as a horse box.

It is an objective of the present invention to overcome disadvantages of the prior art feeding devices without jeopardizing functionality and advantages.

### SUMMARY OF THE INVENTION

The present invention relates in a first aspect to a feeding device 100, in a second aspect to a use thereof, and in a third aspect to reduce physical and mental problems for a horse.

This invention describes a system that can be filled with a relatively large volume of dried grass (or other feeding material) that will be offered to the horse (or other animals) in configurable and relatively small doses. It comprises a container 41 for maintaining forage 21 wherein the shape of the container is preferably selected from a cross-section selected from triangular, square, rectangular, hexagonal, octagonal, multigonal, circular and ellipsoidal, and combinations thereof, wherein the container has a single forage access, which access is substantially at a top side of the container (ergonomically better for the horse), at least one horizontal forage blocker 12,31 (parallel to the surface of the earth ±15 degrees, preferably parallel ±5 degrees) and a timer circuit. It is easy to operate, ergonomically better for e.g. the horse, requires filling only now and then, can be placed in an individual stable box, is cost effective, simple, and supports production of salivary. As it is provided per individual box each horse experience comfort and reassurance. Each device can be optimized for a specific horse, the horse being the resident of the individual box, e.g. in terms of amount of food, timing, intervals, amount of food per interval, etc. It has been found that each individual horse eats with a difference in speed, such as because he is more focused on feed, or because he is more skillful in picking hay through the grid. A timer is digital (open/close), in that in practice one can see how much a horse eats per horse if you work with fixed times during which the horse can eat. And that is not the intention, so you have to adjust the food intake speed in relation to time. This is what the present controller does. For instance, based on the measured volume and/or weight over time it is determined how quickly a horse eats. By varying the times (within limits, such is in view of stomach acid production) the intake per 24 hours is controlled. It has been found that the horses show no abnormal behavior anymore, feel comfortable, show no physical disorders, or at least not due to improper food uptake. As no external moving parts are present, no additional security measures have to be taken, such in order to prevent a horse (head) to get stuck. As a result also the horse cannot bypass or overrule the system.

In geometry, a prism is a polyhedron with an n-sided polygonal base, another congruent parallel base (with the same rotational orientation), and n other faces (necessarily all parallelograms) joining corresponding sides of the two bases. Note that for n=∞ effectively a circle is defined. All cross-sections parallel to the base faces are congruent to the bases. Prisms are named for their base, so a prism with a pentagonal base is called a pentagonal prism. The prisms are a subclass of the prismatoids.

For a horse the container typically holds enough feeding material for a day, so at least 9 kg of dried grass. Hence the container needs to be filled only once a day. Likewise larger containers may be provided; in such cases the containers need to be refilled even less often or may be suitable for larger horse breeds. Even lager containers can be use that are partially submerged below the ground level providing food for several days. As previously stated, this 9 kg is normally consumed in 2 to 3 hours (4 to 6 in combination with bars). For the present invention the timer circuit may divide the daily feeding time over 24 hours and may provide access for a specific period time. When this time has passed, the access is denied for a specific period of time (interval).

A sum of open (accessible) and closed (non-accessible) time (cycle) is preferably kept small to prevent the production of stomach acid in an empty stomach. A good example is a cycle time of 30 minutes; in that case there are 48 cycles per day, which are equivalent to about 125 gr per dosage. When in an example taking a consumption time of 2 hours, such results in an open time of (2*60)/48=2.5 minutes and (30-2.5)=27.5 minutes closed time. In an alternative 5 minutes open time and 25 minutes closed time may be chosen, optionally in combination with bars. The controller can optionally change the open and close time during the day to accommodate for differences in eat behavior between different horses.

By providing e.g. the dried grass in small doses, e.g. 50 gr-500 gr, preferably 100 gr-250 gr, such as 125-150 gr, the stomach continues to be filled and the stomach acid can't irritate the stomach. The horse will quickly recognize that the opening sound means access to dried grass and that dried grass is offered at regular intervals. It will wait for the container to open again reducing the chance of abnormal behavior. The holding container is typically a rectangular or square box; it can have any shape, e.g. in order to fit better in the environment of the animal. An example is a triangular shape that can be placed in the corner of the environment. The volume of the container should preferably hold at minimum the amount of feeding material for one day. Since the feeding time is restricted, it can also be increased to hold feeding material for several days. So in an example a volume is e.g. from approximately 50 dm³-300 dm³, preferably 75 dm³-200 dm³, more preferably 100 dm³-150 dm³. Typical dimensions are a height of 2-7 dm, a length of 2-10 dm and a width of 2-10 dm (for a rectangular shaped container). Therewith the present feeding device is relatively small and can be placed in individual stable boxes.

The at least one forage blocker may relate to a vertically moveable grid 31. Likewise the bottom can be made to move in a vertical manner, wherein in an upward position forage is available, and in a downward position no forage is available. For moving upwards and downwards at least one positioner 51 is provided, such as a positioner which translates rotational movement into vertical movement.

The present device comprises an electrical controller, wherein the controller is in electrical contact with the positioner and capable of activating the positioner in order to open or close the container, i.e. allow or prevent access to the forage.

The present device comprises a timer which is capable of vertically moving the forage blocker. The present timer, which is capable of dosing forage by adapting the forage blocker by allowing forage for a predetermined period of time and preventing forage during at least one predetermined interval, typically a timer circuit (IC), can be part of the feeding system and as a result control the position of the cover for one container or device. It can also be an external circuit that controls one or more containers, typically 2-50 containers, so that all containers open at the same point in time and close at a predetermined point in time. This reduces costs and also prevent that a neighboring animal hears the sound of the cover being opened but can't access the feeding material in its own container possibly resulting in frustrated behavior. So typically each horse has its own feeding device.

In group environments a number of containers can be placed. In that case the feeding system may be extended with a sensor (e.g. RFID) to detect which animal approaches the container. The cycle time can then be adjusted depending how much time the animal has spent at a (specific) container; the time is assumed to represent an amount of food.

Thereby the present invention provides a solution to one or more of the above mentioned problems.

Advantages of the present description are detailed throughout the description.

### BRIEF DESCRIPTION OF THE DRAWINGS

FIG. 1A shows a top view of a horse feeding device,

FIG. 1B shows a side view along direction A of FIG. 1A,

FIG. 1C shows a top view along direction B of FIG. 1A,

FIG. 1D shows a view of an open grid,

FIG. 1E shows an example of a moveable grid, and

FIG. 1F shows a movable grid driven by four straps.

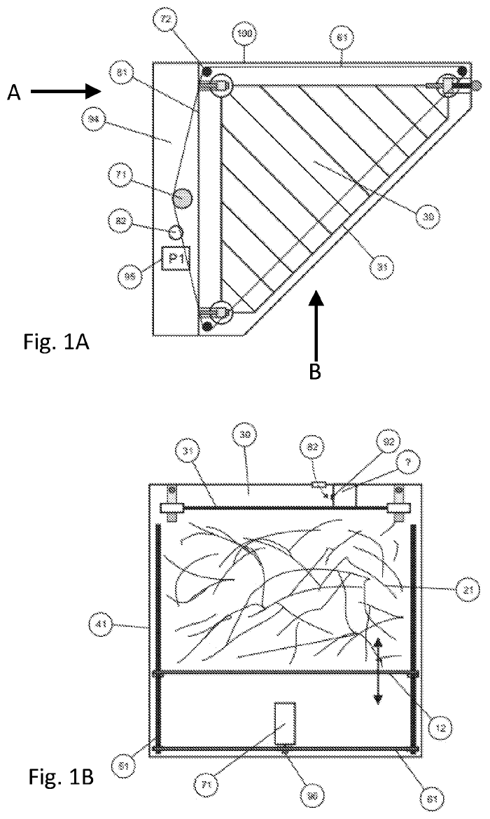

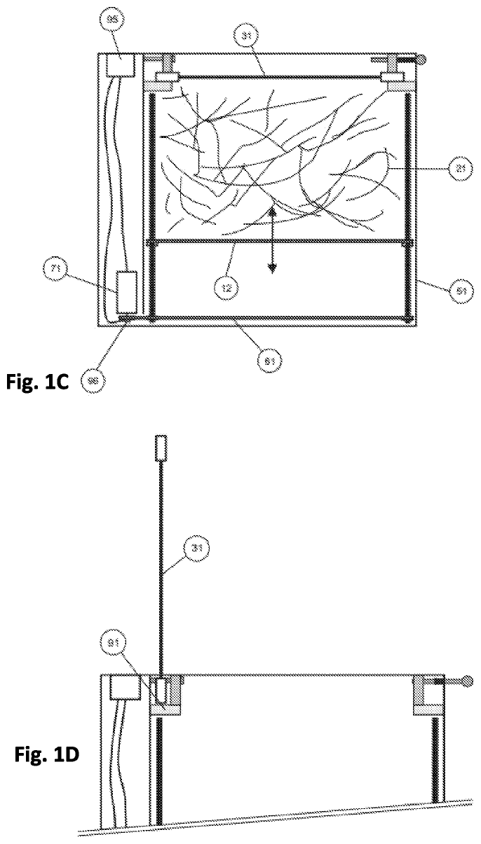

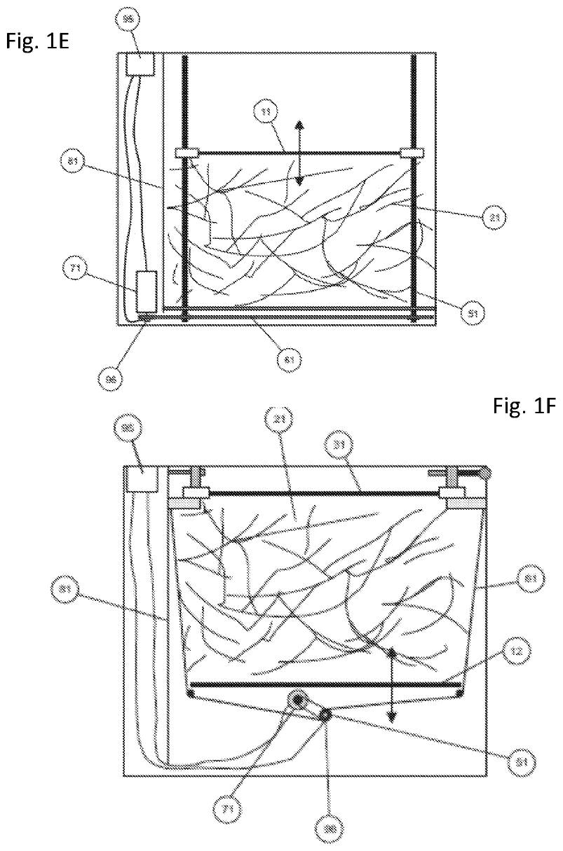

### DESCRIPTION OF THE INVENTION

The present invention relates in a first aspect to a feeding device for use in a horse box.

The present horse feeding device comprises a container for forage; the container (typically above ground level) may have any shape, such as rectangular, triangular, and multigonal, e.g. hexagonal. The height is typically 20-70 cm. The material of the container is preferably a metal, such as stainless steel or aluminium, or a plastic, typically a thermoset plastic.

In an example the present feeding device further comprises a grid. The grid limits or slows down uptake of food by a horse, which is considered beneficial for the well-being of a horse. The grid typically has bars placed at a distance of 4-10 cm from one and another, leaving an open space in between bars of 3-8 cm. Therewith a horse is stimulated to use its lips for up-taking food. It is also found to improve production of salivary and improve digestion of food.

In an exemplary embodiment of the present feeding device the at least one height positioner (51) is for vertically moving the at least one forage blocker at at least one edge thereof, wherein the positioner comprises at least one shaft providing vertical movement, such as a worm gear or strap, and wherein the forage blocker is in mechanical contact with the at least one shaft.

In an exemplary embodiment of the present feeding device the at least one positioner is a scissor lift.

In an exemplary embodiment of the present feeding device the at least one positioner in operation is driven by an electromotor, preferably a (brushless) DC-motor.

In an exemplary embodiment of the present feeding device at each corner of the forage blocker a hollow ring is provided, which hollow ring in operation is driven by the shaft in a vertical direction therewith providing vertical movement.

In an exemplary embodiment of the present feeding device vertical movement of the at least one positioner is provided by a single chain, wherein the chain is in mechanical contact with the at least one shaft.

In an exemplary embodiment of the present feeding device all positioners are coupled to one chain, wherein the chain is coupled to the electromotor.

In an exemplary embodiment of the present feeding device the electromotor and controller are located outside the container, and inside the horse feeding device.

In an exemplary embodiment of the present feeding device the electromotor comprises a rotation sensor and/or a multi-turn resistor.

In an exemplary embodiment of the present feeding device the grid is made of stainless steel or rigid polymer, preferably polished stainless steel, HDPE or POM.

In an exemplary embodiment of the present feeding device grid openings are from 4*4 cm² to 10*10 cm², or wherein a distance between adjacent bars is 40-80 mm, and wherein a grid is adapted to an animal intended to use the present device.

In an exemplary embodiment of the present feeding device the timer and controller are integrated.

In an exemplary embodiment of the present feeding device the timer and controller are separate entities capable of wireless contact, such as with one and another, with wireless devices, such as computers, laptops, smartphones, and tablets.

Especially with nowadays apps and rapid development thereof separate entities may be preferred. Effectively the present system can be controlled by a smart phone; likewise status information can be provided from the present device to the smartphone or the like.

In an exemplary embodiment the present feeding device may comprise a detector, preferably a wireless detector, such as an RFID detector. The detector may detect an identity of an individual horse. Upon detection software may adapt an amount of forage, an interval time, a feeding time, or a combination thereof.

In an exemplary embodiment the present feeding device may comprise a locator, the locator adapted to determine a height of the forage blocker, such as grid or bottom.

In an exemplary embodiment the present feeding device may comprise software, such as software for training, and for status update.

In an exemplary embodiment the present feeding device may comprise calibration information, such as representing positions of the forage blocker.

In an exemplary embodiment the present feeding device may comprise at least one control button 92, which at least one control button is accessible by an opening 82 in a protecting plate 94. Therewith it is prevented that a horse can intentionally or accidentally access control of the present device.

In an exemplary embodiment of the present feeding device a grid is detachably attached, wherein a fixator of the positioner can be removed, and wherein the grid can be move away.

In an exemplary embodiment the present feeding device may comprise at least one receptor (91) such as for receiving the moveable grid.

In an exemplary embodiment the present feeding device may comprise a removable horizontal cover (11) for covering at least partly at least a top side of the container, wherein the at least one cover (11) is selected from a flexible material, such as a polymer sheet, from a shutter, a screen, a second grid having small openings, a sliding cover, a rolling cover, a rotating cover, and an iris-shaped cover. The present device may comprise at least one removable horizontal cover for covering at least partly at least a top side of the container. The at least one cover prevents horses from eating. The cover may be made of a metal, typically a metal sheet, or a plastic, having sufficient deformability and strength. In the present application the term “cover” also refers to “at least one cover”. The present cover can be made in several ways as long as it provides a barrier between the animal and the feeding material. Examples are sliding covers, rolling covers, rotating covers, and iris shaped covers. The cover may be formed of one part, or may be made out of sub-parts. Also more than one cover may be provided, such as a cover located at a back side and at a front side of the container. The covers can be completely closed but also partly open allowing air to enter the container. Some type of covers are preferred in view of reduction of elements of the present device; for instance if an iris shaped cover is used a receptor may be left out. In an example the present feeding device further comprises at least one receptor for receiving the at least one cover, typically a separate space. The separate space is preferably not directly accessible from an outside, e.g. in view of safety. Typically one receptor per cover is provided. It is preferred to use one or two covers and equivalently one or two receptors.

In an exemplary embodiment the present feeding device may comprise an intermediate wall between the receptor and container, the wall having an opening for receiving the cover. Therewith the forage and positioner, and likewise the cover in an open position, are largely separated from the forage, which is more hygienic and prevents accidents.

In an example the present feeding device further comprises at least one of a housing, and an anchoring point. The housing typically comprising all the elements of the present feeding device. The at least one anchoring point is for anchoring the present device, e.g. to a wall and/or floor of a stable thereby securing the device. In addition a control panel, a status indicator, or both may be provided, typically on an outside of the housing.

In an exemplary embodiment of the present feeding device the forage is selected from at least one of hay, (dried) grass, and straw, which are considered to relate to typical food for a horse.

In a second aspect the present invention relates to a method of operating the present device, wherein the cover is opened during an opening period of 1-10 minutes, and thereafter is closed during an interval of 1-60 minutes.

In an example of the present method the intervals and openings are spread evenly over a day.

In an example of the present method the intervals and opening periods are continued for 18-23 hours, and wherein in between the device is closed for less than 1-6 hours.

In an example of the present method a sum of an opening period time and interval time is between 20-60 minutes.

By adapting open times, intervals, opening periods, and so on, an amount of food per unit time, a total amount of food, a total amount of rest, and so on, can be adjusted for each individual horse, therewith contributing to physical and mental well-being.

In an example of the present method the sum is kept constant within ±10% relative.

In a third aspect the present invention relates to a use of the present method for reducing at least one of a gastro-enteric disorder, a digestion disorder, a stomach disorder, a mental disorder, etc. It has been found that the present device and method reduce physical complaints significantly (30-90% of instances) and improve behaviour and mental well-being (abnormal behaviour being observed only incidentally versus typically in prior art methods).

The invention is further detailed by the accompanying figures and examples, which are exemplary and explanatory of nature and are not limiting the scope of the invention. To the person skilled in the art it may be clear that many variants, being obvious or not, may be conceivable falling within the scope of protection, defined by the present claims.

The invention although described in detailed explanatory context may be best understood in conjunction with the accompanying examples and figures.

In the figures:
100 feeding device
11 movable horizontal cover
12 vertically movable bottom
21 forage
30 single feeding access
31 grid
41 container
51 positioner
61 chain, belt or strap
71 motor/chain axis
72 chain gear wheel
81 intermediate wall
82 opening
91 receptor
92 control button
94 protecting plate
95 electronics
96 rotation encoder

It should be appreciated that for commercial application it may be preferable to use one or more variations of the present system, which would similar be to the ones disclosed in the present application and are within the spirit of the invention.

1-24. (canceled)

25. An individual horse feeding device for use inside or outside a horse box, wherein the use is for reducing at least one of a gastro-enteric disorder, a digestion disorder, a stomach disorder, and a mental disorder, comprising
a container for maintaining forage, having a volume of 50 dm³-300 dm³, wherein the container has a single forage access, which access is substantially at a top side of the container, wherein the shape of the container is preferably a regular prism,
comprising at least one horizontal forage blocker, selected from a vertically moveable grid, or a vertically moveable bottom,
at least one height positioner for moving the forage blocker, wherein the at least one height positioner is for vertically moving the at least one forage blocker at at least one edge thereof,
an electrical controller, wherein the controller is in electrical contact with the positioner and capable of activating the positioner, and wherein the controller is adapted to optimize feed provision for an individual horse, and
a timer which is capable of dosing forage by adapting the forage blocker by allowing forage for a predetermined period of time and preventing forage during at least one predetermined interval, wherein the timer is adapted to make the forage accessible during an opening period of 1-10 minutes, and wherein the timer is adapted to thereafter make the forage not accessible during an interval of 1-60 minutes.

26. The horse feeding device according to claim 25, wherein the positioner comprises at least one shaft providing vertical movement, such as a worm gear, and wherein the forage blocker is in mechanical contact with the at least one shaft, or wherein the at least one positioner is a scissor lift, wherein the at least one positioner in operation is driven by an electromotor, preferably a brushless DC-motor.

27. The horse feeding device according to claim 26, wherein the electromotor comprises a rotation sensor and/or a multi-turn resistor.

28. The horse feeding device according to claim 25, wherein the vertically moveable grid is made of stainless steel or rigid polymer, preferably polished stainless steel or POM, and/or wherein vertically moveable grid openings are from 4*4 cm² to 10*10 cm², or wherein a distance between adjacent bars is 40-80 mm, and wherein the vertically moveable grid is adapted to an animal intended to use the present device.

29. The horse feeding device according to claim 25, wherein the timer and controller are integrated, or are separate entities capable of wireless contact, such as with one and another, with wireless devices, such as computers, laptops, smartphones, and tablets.

30. The horse feeding device according to claim 25, further comprising a detector, preferably a wireless detector, such as an RFID detector, and/or
a locator, the locator adapted to determine a height of the vertically moveable grid or bottom, and/or
software, such as software for training, and for status update, and/or
calibration information, and/or
at least one control button, which at least one control button is accessible by an opening in a protecting plate.

31. The horse feeding device according to claim 25, wherein the vertically moveable grid is made of stainless steel or rigid polymer, preferably polished stainless steel or POM, and/or wherein vertically moveable grid openings are from 4*4 cm² to 10*10 cm², or wherein a distance between adjacent bars is 40-80 mm, and wherein the vertically moveable grid is adapted to an animal intended to use the present device, the device further comprising a detector, preferably a wireless detector, such as an RFID detector, and/or
a locator, the locator adapted to determine a height of the vertically moveable grid or bottom, and/or
software, such as software for training, and for status update, and/or
calibration information, and/or
at least one control button, which at least one control button is accessible by an opening in a protecting plate.

32. The horse feeding device according to claim 25, wherein the positioner for moving the forage blocker is adapted to move at least one cover between an open and closed position or for moving the bottom or vertically moveable grid upwards or downwards.

33. The horse feeding device according to claim 25, wherein the container is triangular, rectangular, pentangular, or hexangular.

34. The horse feeding device according to claim 25, wherein the vertically moveable grid is detachably attached, wherein a fixator of the positioner can be removed, and wherein the vertically moveable grid can be move away.

35. The horse feeding device according to claim 25, wherein the forage blocker comprises a removable horizontal cover for covering at least partly at least a top side of the container, wherein the at least one cover is selected from a flexible material, such as a polymer sheet, from a shutter, a screen, a second grid having small openings, a sliding cover, a rolling cover, a rotating cover, and an iris-shaped cover.

36. The horse feeding device according to claim 25, further comprising at least one of a housing, and an anchoring point.

37. The horse feeding device according to claim 25, wherein the forage blocker comprises a removable horizontal cover for covering at least partly at least a top side of the container, wherein the at least one cover is selected from a flexible material, such as a polymer sheet, from a shutter, a screen, a second grid having small openings, a sliding cover, a rolling cover, a rotating cover, and an iris-shaped cover and wherein the positioner for moving the forage blocker is adapted to move at least one cover between an open and closed position or for moving the bottom or vertically moveable grid upwards or downwards.

38. The horse feeding device according to claim 25, wherein the forage blocker comprises a removable horizontal cover for covering at least partly at least a top side of the container, wherein the at least one cover is selected from a flexible material, such as a polymer sheet, from a shutter, a screen, a second grid having small openings, a sliding cover, a rolling cover, a rotating cover, and an iris-shaped cover and wherein the container is triangular, rectangular, pentangular, or hexangular.

39. The horse feeding device according to claim 25, wherein the forage blocker comprises a removable horizontal cover for covering at least partly at least a top side of the container, wherein the at least one cover is selected from a flexible material, such as a polymer sheet, from a shutter, a screen, a second grid having small openings, a sliding cover, a rolling cover, a rotating cover, and an iris-shaped cover and wherein the positioner for moving the forage blocker is adapted to move at least one cover between an open and closed position or for moving the bottom or vertically moveable grid upwards or downwards and wherein the container is triangular, rectangular, pentangular, or hexangular.

40. The horse feeding device according to claim 25, further comprising at least one of a housing, and an anchoring point and wherein the container is triangular, rectangular, pentangular, or hexangular.

41. A method of operating a horse feeding device according to claim 25, wherein the forage is accessible during an opening period of 1-10 minutes, and thereafter is not accessible during an interval of 1-60 minutes.

42. The method according to claim 41, wherein the intervals and access are spread evenly over a day.

43. The method according to claim 41, wherein the intervals and access periods are continued for 18-23 hours, and wherein in between the device is not accessible for less than 1-8 hours.

44. The method according to claim 41, wherein the intervals and access are spread evenly over a day and wherein the intervals and access periods are continued for 18-23 hours, and wherein in between the device is not accessible for less than 1-8 hours.
